(19) United States
(12) Patent Application Publication
(10) Pub. No.: US 2005/0285747 A1
(43) Pub. Date: Dec. 29, 2005

(54) Biometrically authenticated telecommunications system for probation release monitoring programs and other security-oriented applications

(76) Inventor: Douglas Kozlay, Timonium, MD (US)

Correspondence Address: Douglas Kozlay, Suite 410, 9475 Deereco Road, Timonium, MD, 21093, US

(21) Appl. No.: 10/876,828

(22) Filed: Jun. 24, 2004

(51) Int. Cl. G08B 23/00

(52) U.S. Cl. 340/573.4; 340/539.13

(57) ABSTRACT

A biometrically authenticated, ergonomic, telecommunicating geographic position locating system, apparatus, and method is disclosed. The invention uses fingerprint biometrics and GPS, facilitating probationary release of lower-priority, non-violent offenders into “house arrest” detention, in lieu of more expensive prison detention. The invention allows federal, state, or local authorities to provide an accurate, economical “Probation Release System” application. The invention uses biometrics and GPS embedded in cellular telephones carried by released, probationary persons. Central site monitoring capabilities of the invention allow constant monitoring of many probationary persons' movements. Authorities can contact any probationary individual any time to request they provide fingerprint verification and GPS position location. The invention enables authorities to save money and reduce populations at prison facilities, allowing authorities to prioritize dedication of expensive prison facilities to violent and/or serious offenders.

### BACKGROUND OF THE INVENTION

1. Field of the Invention

The field of the invention is secure geographic position locating systems, more particularly, a secure geographic position locating system adapted for providing a “Probation Release Program” application.

2. Related Art

U.S. Pat. No. 6,512,456 to Taylor discloses a mobile medical monitoring device which provides for monitoring a predetermined set of bodily functions, while being trackable such that medical intervention may be employed in response to the detection of the onset of a medical crisis.

While it is expected that this is useful for certain medical related and location related applications, it would appear that the security of the device is relatively limited. Unlike the present invention, the mobile medical monitoring device will not assure a monitoring person or a central system of the explicit identity of the person operating it.

U.S. Pat. No. 6,463,127 to Maier, et al., discloses a method for minimum supervision of an offender who is required to report in to an electronic supervision system. The method includes pre-enrolling an offender into the electronic supervision system, as well as assigning an authorized telephone number to him or her. When a required “report in” telephone call is placed by an individual from their assigned telephone at their assigned remote location, the remote location telephone will provide and demonstrate its' originating telephone number to the central location. The telephone call from the assigned remote location is accepted by the authorities at the central location and it is determined whether the ANI (automatic number identification) feature of the originating telephone number is available. If available, the ANI of the originating phone number is captured. An enrollee ID number assigned to the offender is entered. The originating telephone number is validated against the authorized telephone number assigned to the offender to verify the location of the remote telephone. It is determined whether a voice template is on file for the offender. The individual is prompted to respond to a plurality of user definable inquiries regarding the status of the offender. The identity of the individual placing the telephone call is verified using voice verification technology during the telephone call.

While this invention appears having utility for the exact application described, it is limited when compared to the present invention, due to the apparent reliance of the invention upon cognizant authorities receiving ANI signals from remote telephones, and accessing voice templates and voice verification technology. The invention as disclosed and claimed appears to rely on a very sophisticated large-scale centralized infrastructure to support derivation of ANI signal intelligence, retrieval of individuals' stored voice template records from voice template databases, and use of comparison processes for comparing accessed stored voice templates with real-time voice recognition inputs.

U.S. Pat. No. 6,198,390 to Schlager, et al discloses an invention having a personal alarm system with a navigational receiver for receiving navigational information; a demodulator for demodulating the received navigational information; timing circuits for providing precise time of day information; a manually operated switch defining a panic button, and having an output signal defining a switch status wherein operation of the panic button produces a change in the switch status; and a radio transmitter for transmitting the demodulated navigational information, time of day information, and switch status. Additional embodiments further disclose remote units for a man overboard system, an invisible fence system, and a weather alarm system.

However, U.S. Patent to Schlager, et al does not offer significant security to ensure that the one, specific person who is operating the remote unit is in fact the one, specific person who is assigned to operate the remote unit, even though there is a position-locating capability disclosed in the patent. While this may be a moot point with regard to a personal alarm system, it is obvious that the system can be spoofed without difficulty.

U.S. Pat. No. 6,160,481 to Taylor discloses a system able to monitor person and able to take an action in the form of intervention dissuading the person from a course of action. The intervention may be in the form of delivery of either a medication or an electrical shock to the person. The Taylor Patent further discloses monitoring of a bodily function of the person or geographic positional tracking of the person. Another embodiment described in the Taylor patent's disclosure includes a second device in possession of a “restrictor person” having control of geographic positional tracking of a “restricted person”, and the capability to compare the actual position of the “restricted person” relative to the expected or assigned positional location of the “restricted person”, to determine if the person is indeed located where he or she is expected or assigned to be located.

While the Taylor Patent discloses merit and utility for some applications, it is apparent that it is a “physically tethered” system and appears to require some degree of attachment onto the body of the person being monitored. It appears that Taylor Patent offers less operational flexibility and more restrictive in operations for both the monitored individual and for the monitoring individual, when compared to the present invention. Furthermore, there is no provision for a fingerprint monitoring capability in the Taylor Patent, such as provided by the present invention.

U.S. Pat. No. 6,100,806 to Gaukel discloses an apparatus for continuous electronic monitoring and tracking of individuals, using GPS and cellular telephone communications. The apparatus may include first and second remote units adapted to be worn on the monitored person or object. These remote units would comprise the position and data sensors as well as the transmitter device to transmit the information back to a central tracking station. The remote units may be operative to monitor many data items such as system integrity, motion, temperature, audio, and location of a geographic position of a person. This data is transmitted back to the central monitoring station to process and display the information.

While there appears to be utility in this invention, there also appears to be no secure means for verifying the identity of individuals being tracked, unlike the secure biometric capabilities offered by the present invention.

U.S. Pat. No. 5,982,281 to Layson discloses an offender and victim “collision avoidance” invention with an “advanced” warning system. While the invention may be useful for house arrest or home parole usage, it does not offer a fingerprint sensing capability such as that offered by the present invention.

U.S. Pat. No. 5,963,130 to Schlager discloses a self-locating remote monitoring system with a supervising base station and one or more remote monitoring units. A remote unit includes a navigational receiver operating in conjunction with an existing navigational system for providing the remote unit's location, and a transmitter for communicating the location to the base station for display. The remote unit includes one or more physiological or environmental sensors for monitoring at the remote location. In one specific embodiment, a change in sensor status results in the status and the location being transmitted to the base station.

While the invention appears useful, it is silent on the topic of verification of the user of the remote units. When compared with the present invention, it appears obvious that the security offered by the Schlager Patent cannot compare with the security of the present invention.

U.S. Pat. No. 5,889,474 to LaDue discloses a method and apparatus for transmitting subject status and location of a parolee or individual under house arrest, to a central monitoring station (CMS) operated by a parole staff or correctional facility. The subject status information is transmitted by a band or collar attached to the body (e.g., leg or wrist) of the subject. A cellular radio communicator receives, encodes and transmits the subject status information over the control channel of a cellular radio communications network to a mobile switching center (MSC) of the cellular radio communications network. The MSC decodes and forwards the subject status information over the public switched telephone network (PSTN) to the CMS. Optionally, the MSC may send a command to the communicator over the same data paths, i.e., the PSTN to the MSC, then over the control channel, formatted as a control signal, to the cellular radio communications network communicator. The communicator may integrate a paging receiver, or a satellite receiver, or other wireless receiver for receiving commands out of band (i.e., by way of communication networks other than the cellular radio communications network). The method and apparatus may also be utilized to track the position of more than one subject relative to other subjects or objects.

However much utility there may be in this patent and the product it protects, there is no provision for ensuring that the person who is operating the unit or wearing the unit (and being monitored) is in fact the specific person who is assigned or mandated to be operating or wearing the unit. U.S. Pat. No. 5,867,103 to Taylor discloses a monitored person tracking system, which provides a portable monitoring device for each person being monitored. The device receives a signal from a detached sending unit and transmits a signal for transfer to a central location.

Whatever utility there may be in this patent and the product it protects, there is no provision for ensuring that the person who is operating the unit or wearing the unit (and being monitored) is in fact the specific person who is assigned or mandated to be operating or wearing the unit.

U.S. Pat. No. 5,825,283 to Camhi discloses a system for the security and auditing of persons and property. The system provides an apparatus for monitoring subjects by a location determining device which provides the location of the subject to a processor. The processor is configured to monitor location with respect to predefined safety or security related limits. Further configuration of the processor includes geographical boundaries and also allows inclusion of alerting options to concerned individuals so that proper corrective action may be taken. Configuration of the processor may further include remote programming of the geographic boundaries by authorized personnel via a communication link. Additionally, processor inputs may be coupled to other systems, equipment, or sensors in order to monitor operational variables or outputs of the coupled devices indicative of safety or security concerns.

While there is some general reference to sensors for monitoring at least one physiological parameter of the subject, there is no mention of inclusion of a fingerprint sensor to verify the identity of the person who is using the device disclosed in the patent. The invention appears utilitarian for some applications, however, it does not appear to contain the requisite amount of security provisions therein, such as the fingerprint sensor provided by the present invention.

U.S. Pat. No. 5,731,757 to Layson teaches a portable tracking apparatus for continuous position determination of criminal offenders and victims.

While this patent and the product it protects appears useful for some applications, there is no provision for ensuring that the person who is operating the unit or wearing the unit (and being monitored) is in fact the specific person who is assigned or mandated to be operating or wearing the unit.

U.S. Pat. No. 5,461,390 to Hoshen, usable with an already predefined database system, discloses a locator device having utility for house arrest and stalker detection, which is useful for monitoring the location of subjects.

While this patent and the product it protects appears useful for some applications, there is no provision for ensuring that the person who is operating the unit or wearing the unit (and being monitored) is in fact the specific person who is assigned or mandated to be operating or wearing the unit.

U.S. Pat. No. 5,204,670 to Stinton discloses a personnel monitoring system. The monitoring system includes a host central processing unit (CPU) maintained by a supervising agency that automatically, or by request, receives and interprets data from individuals being monitored. The monitored individuals may wear or carry a transmitting or transponding unit that periodically, or upon request, transmits a uniquely encoded signal that not only identifies the person, but includes information about the condition or activities of the person being monitored. Lower risk monitored individuals may be required to simply contact the host CPU on a regular basis. The host CPU includes a plurality of software sub-modules that can be selectively installed therein to allow a desired monitoring configuration to be used in order to best meet the needs of the monitoring agency. The communication link between the individual and the CPU may be by way of existing telephone lines or other telecommunication links. From data received, the host CPU generates reports indicating the location, condition, status, and/or activities of the monitored individual.

While this patent and the product it protects appears useful for some applications, there is no provision for ensuring that the person who is operating the unit or wearing the unit (and being monitored) is in fact the specific person who is assigned or mandated to be operating or wearing the unit.

Additionally, some U.S. Patents address implementing fingerprint sensors and cell phones, such as U.S. Pat. Nos. 6,408,232 and 5,924,025. Notwithstanding, while these patents and the products they protect have utility, there is no “probation release system” application disclosed with means for ensuring that the person who is operating the unit or wearing the unit (and being monitored) is in fact the specific person who is assigned or mandated to be operating or wearing the unit.

Although the aforesaid related art makes contributions to the field of the invention, it is evident that the present invention provides significant features and benefits unavailable in the prior related art.

### Necessity of the Invention

It is estimated, between $20,000 and $60,000 per year is expended on each incarcerated person in the US (costs vary from state to state and prison). The present invention allows and facilitates the probation release (and/or parole) of non-violent offenders and/or relatively small-time offenders, instead of expensive and frequently inappropriate long extended detention.

It is obvious that there is a major need to reduce the size and the cost of supporting a large prison population, particularly as it relates to perpetrators of relatively non-violent, non-severe crimes. It is also obvious, there are major unresolved humanitarian needs and considerations that need to be addressed, ameliorated, and dealt with in ways that will satisfy society. The system used must be inexpensive and simple to deploy and ideally should be easily useable and available to the subject as a cell phone.

### OBJECTS OF THE INVENTION

Accordingly, it is a primary object of the invention, to provide a humanitarian alternative to conventional and costly incarceration for non-violent and low-priority offenders.

One of several primary objects of the invention is to provide a self-contained, secure, and geographic position locating system capable of providing an accurate and reliable probation release system that is easily adaptable by a central monitoring authority or other cognizant authority, to expand or restrict the operating boundaries of the system (i.e., based on time of the day and/or existence of emergency situations, etc.), contingent upon prevailing operational circumstances.

It is another object of the invention to provide a security-oriented unit with remotely usable functionality capable of assigning the invention to a specific individual whose fingerprint is needed to verify the fact, that specific individual is in fact using the unit as assigned. This will prevent spoofing the system and can eliminate the need for attaching and maintaining leg or wrist bands.

Further, it is another object of the invention to provide a low cost system that is affordable by penal authorities as well as parolees with the expectation that the parolees will be able to afford to pay part or all of the cost of the remote security oriented unit which they are assigned to carry.

In summary, various embodiments of the invention use biometrics data to assure parolees' and probationers' identities, with the aim of providing a probation release monitoring system for the purpose of electronically monitoring and verifying that parolees and probationers remain within the predefined geographic perimeters (perambulation limits) of their probation release agreements. In addition, the system can also be adapted for other military or civilian applications which can electronically enforce perambulation within (or outside of) predefined or undefined geographic limits.

### SUMMARY OF THE INVENTION

The present invention is essentially based either upon a cellular telephone individually or other telecommunicating device individually or a combination of a cellular telephone and another telecommunicating device serving as a communications platform with addition of an embedded GPS geographic position locating subsystem. The system further includes either an embedded fingerprint sensor subsystem and/or an optional interface subsystem for communicating with a user-authenticating biometric smartcard. The system is ergonomic in nature due to its' familiar cell phone platform format, and the system is intuitive to operate and easy to use.

In the case of the embodiment of the present invention with the embedded fingerprint sensor subsystem, the cellular telephone platform individually (or other telecommunicating device individually, or the combination of cellular telephone and another telecommunicating device) is configured to receive user-authenticating fingerprint data inputs from the embedded fingerprint sensor subsystem in response to randomly-timed authentication demands (prompts) to the user for immediate self-authentication. These randomly-timed prompts may originate in the portable device, itself, or may be transmitted from a control center.

In the case of the embodiment of the present invention with the interface subsystem for communicating with a user-authenticating biometric smartcard, the cellular telephone platform individually (or other telecommunicating device individually, or combination of cellular telephone and other telecommunicating device, such as a data pager) is configured to receive verification inputs from the biometrically authenticated and enabled smartcard via the smartcard interface subsystem in response to randomly-timed, externally or internally initiated authentication demands (prompts) to the assigned or mandated user, that he or she immediately self-authenticate.

### BRIEF DESCRIPTION OF THE DRAWINGS

FIG. 1 is an illustration of parolee remote Unit which includes display, GPS receiver and antenna, and onboard fingerprint sensor;

FIG. 2 is an illustration of a display showing a city map with an enlargement of the area of interest and with a link to a database containing official data and reports on the person being monitored; and

FIG. 3 is an illustration of views of control center console showing the same city map and persons being monitored.

### DETAILED DESCRIPTION OF THE PREFERRED EMBODIMENT

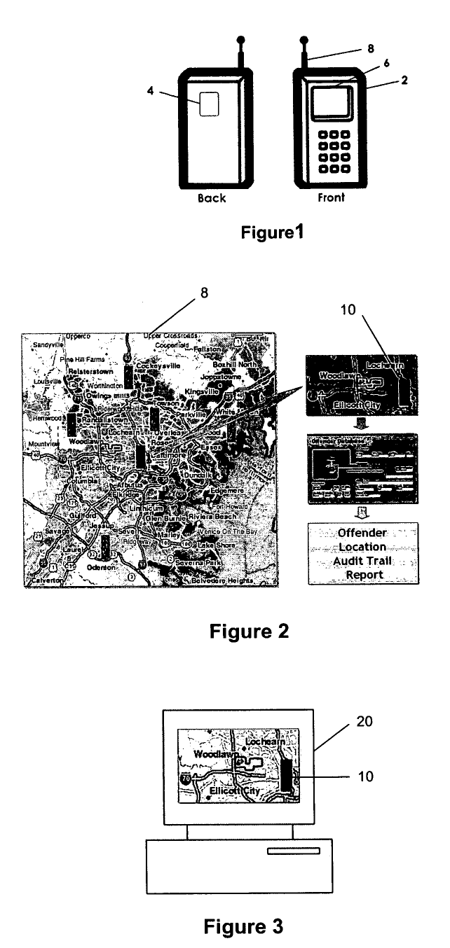

Turning now to FIG. 1, the parolee remote unit 2 of the probation release system is shown. The unit may appear initially to the observer, to be a cellular telephone. However, although the present invention is indeed based on a cellular telephone platform, there are many more features and benefits offered. It can be further seen in FIG. 1, that fingerprint sensor 4 is prominently visible upon the body of remote unit 2. Display 6 and GPS receiver and antenna 8 also can be seen on remote unit 2. It is important to note, the critical features of this invention in combination with a cell phone and/or other telecommunicating device, are its' GPS features and position locating capability, its' fingerprint sensor features and user authentication capability, and its' probation release supervisory features which can be adjusted “on the fly” in response to changing circumstances, by a probation release supervisory official responsible for monitoring, controlling, and communicating with persons being monitored by the probation release system of the present invention. It must also be noted, the present invention can be implemented and configured to interface with a biometrically authenticating smartcard (not shown), in some versions of the invention. Additionally, it is important to note, that since cell telephones do not have 100% coverage in all possible geographic locations, it is anticipated that one optional version of the remote unit 2 may be a data pager, or alternatively for fullest coverage, the supervisor or administrator of the probation release system may require the probationer to simultaneously use a cell phone communications platform and/or another telecommunicating device, such as a satellite data pager.

FIG. 2 shows a detailed view of display 6 showing a segment of a city map 8 with one icon 10 depicted. Icon 10 represents the remote unit 2 operator's position thereupon, within delineated boundaries displayed city map 8 displayed on display 6. Two different basic types of operator position icons can be displayed on unit 2, to demonstrate the position of person(s) being monitored. Such icons can typically be represented by, e.g., a “stick figure icon” showing a “walking person in a field of color GREEN” (not shown in color), signifying that one or more persons being monitored and tracked are in “GREEN” (allowed) locations. As a counterpoint, a stick figure icon showing a “walking person in a field of color RED” (not shown in color), signifying that one or more persons being monitored and tracked are located in “RED” (not allowed) locations.

FIG. 3 shows a detailed view of control center console 20. The same city map displayed in FIG. 2 may be displayed on console 20.

It should also be noted, in accordance with existing practice, it is necessary to obtain and pay for an account with a cellular telephone system provider (expected to be at the expense of the probationer in most cases, in order to save the probation release system operator money.) Additionally or alternatively, it may be required for the probationer to obtain and pay for a data pager account, or a satellite data pager account (especially in some remote rural locations).

### Probation Release System Operation

The operation of the probation release system is straightforward, ergonomic, intuitive, and easy to use. Essentially, a probationary person (an authenticable user) is assigned and/or mandated to use the probation release system remote unit wherever they go. They are generally required to remain within explicit predefined geographic boundaries (or perambulation limits) in order to comply with the terms of their parole or probation. The user themselves may—or may not—have a remote unit which displays their location to them (by means of an onboard GPS subsystem) with respect to their perambulation limits (the remote unit 2 illustrated, does provide a display to the user). Once the probationary user has been assigned their remote monitoring unit and the unit has been put into operation, then the probation release system supervisor or administrator will receive frequent updates as to the location of the probationary person. Such updates are generally continuously updated on the supervisory console. Should the probationer have a valid reason to leave their predetermined perambulation limits, they can contact the supervisor (e.g., with a request for permission to go to the hospital for a medical emergency) and the

1. A secure, ergonomic, telecommunicating geographic position locating system adapted for monitoring and verifying that assigned users remain within predefined geographic perimeters (perambulation limits), comprising: at least one geographic position locating apparatus for implementing a geographic boundary-oriented probation release system, at least one authorized and biometrically authenticable user, at least one supervisory monitoring, controlling and communicating system, at least one supervisory person, means for communicating between the authenticable probationer user and the supervisory monitoring, controlling and communicating system, and geographic position locating means for providing GPS signals for use in the probation release apparatus and for use in the supervisory monitoring, controlling, and communicating system.

2. A geographic position locating apparatus for implementing a probation release system, comprising: at least one of a cellular telephone and an alternative telecommunicating device such as at least one of a data pager and a satellite pager, further comprising an onboard GPS subsystem for geographic position locating of at least one assigned and authenticable user and further adapted for communicating with a supervisory monitoring, controlling, and communicating system, and a fingerprint authentication subsystem.

3. The apparatus of claim 2 where the fingerprint authentication subsystem resides on a separate smartcard which can be interfaced with said at least one of a cellular telephone and optionally at least one of an alternative telecommunicating device including a data pager and a satellite pager.

4. The apparatus of claim 2 where the fingerprint authentication subsystem, GPS subsystem and cell phone are mounted in one portable device.

5. The apparatus of claim 2 where the fingerprint authentication subsystem and the GPS subsystem are mounted in a satellite pager.

6. The system of claim 1, wherein said perambulation limits can be adjusted “on the fly” by said supervisory person and said monitoring, controlling and communicating system, in response to said probationer user's valid permissible request or changes that have been made to court orders.
